(19) United States
(12) Patent Application Publication
(10) Pub. No.: US 2011/0254426 A1
(43) Pub. Date: Oct. 20, 2011

(54) WIDE-ANGLE ILLUMINATION LIGHT-EMITTING DIODE (LED) LIGHT BULB

(76) Inventor: HSIANG-HUA WANG, Taipei City (TW)

(21) Appl. No.: 12/899,506

(22) Filed: Oct. 6, 2010

(30) Foreign Application Priority Data
Apr. 14, 2010 (TW) 099111579

(51) Int. Cl. H01J 61/52

(52) U.S. Cl. 313/46

(57) ABSTRACT

A wide-angle illumination light-emitting diode (LED) light bulb includes a light base formed of a heat dissipation module having an end to which a circuit board is mounted. The circuit board carries at least one LED that is mounted to the circuit board in a chip-on-board fashion. A global cover is arranged above and covers the LED of the light base heat dissipation module. Intense white light generated by the LED is allowed to emit from the global cover with a wide angle of illumination similar to a conventional light bulb thereby realizing wide and uniform illumination.

### TECHNICAL FIELD OF THE INVENTION

The present invention generally relates to a wide-angle illumination light-emitting diode (LED) light bulb, and more particularly to a wide-angle illumination LED light bulb that provides radiation like light emission similar to the conventional light bulbs.

### DESCRIPTION OF THE PRIOR ART

Light-emitting diodes (LEDs) have been widely used in lightings, such as fluorescent lamp, ceiling lighting, projection light, and light bulb, and shows satisfactory performance in all these applications. However, an LED gives off light only in a predetermined direction. Thus, LEDs have excellent applications in lighting devices that project light in a single direction, such as flash light, projection light, ceiling lighting, and fluorescent lamp. However, the application of LED in a lighting device that gives off radiation-like light emission (wide-angle illumination), such as light bulb, faces more severe challenges than the above discussed LED lighting devices and various problems must be overcome before such an application succeeds.

Reference is now made to FIG. 6, a conventional LED light bulb is shown, which comprises a base 50 having an end carrying a circuit board 60. A plurality of LEDs 70 is attached to the circuit board 60 through surface-mounting technology with a global cover (not shown in the drawing) additionally arranged thereon to form a global light bulb. Referring to FIGS. 6 and 7, the LEDs 70 used in the conventional light bulb show a structure that comprises an outer circumferential wall 71 defining an interior space in which an LED die 73 enclosed by fluorescent powder contained packaging resin 72 is arranged. The light emitting from LED die 73 is only allowed to travel in a frontward direction and propagates along the circumferential wall 71. Such a structure suffers some disadvantages:

(1) The light emitting from the LED die 73 is subjected to blocking by the circumferential wall 71 and provides only an illumination angle not exceeding 120 degrees. This makes the light bulb of this structure impossible to illuminate a wide-angle range and this is considered the primary drawback of the light bulb of this structure. As shown in FIG. 8, experiment results reveal that illumination realized by the light bulb of this structure has primary brightness of first light shape distribution contour (C1) and secondary brightness of second light shape distribution contour (C2) both being established around or above a horizontal line (L0) of the end of the base 50. Apparently, the space below the global cover, which is designated at 80, is of extremely illumination, making it very dark. This is the major drawback.

(2) As shown in FIG. 6, the conventional LEDs 70 are packaging-completed components (dies), which are attached to the circuit board 60 carried by the base 60 through surface-mounting technology. Thus, the conventional LEDs 70 are bulky and require a large amount of installation space, making an unnecessary increase of the spacing S between adjacent LEDs. This leads to occupation of a large amount of surface area of the circuit board 60 when a large number of LEDs are used. Further, heat dissipation must also be realized through size-increased heat dissipation module. As a result, costs are increased. Also, bulkiness is another drawback of the final product.

### SUMMARY OF THE INVENTION

The primary objective of the present invention is to provide a wide-angle illumination light-emitting diode (LED) light bulb, which comprises a light base formed of a heat dissipation module having an end to which a circuit board is mounted. One or more high-power LEDs are mounted to the circuit board in a chip-on-board fashion. A global cover is arranged above and covers the LEDs of the light base heat dissipation module. Thus, when the light bulb of the present invention is put into use, since the LEDs are mounted to the circuit board in a chip-on-board (COB) fashion, the angle of illumination of the LEDs is close to 180 degrees. An additional feature is a unique coating formed on an inside surface of the global cover, which help further expanding the angular range of illumination to at least 270 degrees for light emission from the light bulb. The overall brightness realized by the light bulb is such that primary lighting from the bulb can reach a lower portion of the bulb below a horizontal line of the light base, making the lower portion sufficiently illuminated.

In view of the unique arrangement provided by the present invention, the angular range of illumination and lighting uniformization are very similar to the radiating lighting provided by the conventional tungsten-filament light bulb and energy-saving bulbs. The cost of using the LED light bulb of the present invention is high, but the life span is extended. Further, the light bulb of the present invention is better in terms of environmental conservation and emission of brightness. This is one of the major advantages of the present invention.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view, partially broken, of the light-emitting diode (LED) light bulb according to the present invention.

FIG. 2 is a cross-sectional view of the LED light bulb according to the present invention.

FIG. 3 is a cross-sectional view illustrating the performance of the LED light bulb of the present invention.

FIG. 4 is a schematic view illustrating light shape distribution contours of the LED light bulb according to the present invention.

FIG. 5 is a cross-sectional view illustrating angular range of illumination provided by an LED mounted to a circuit board in a chip-on-board (COB) fashion according to the present invention.

FIG. 6 is a perspective view showing the arrangement of a light base and LEDs of a conventional LED light bulb.

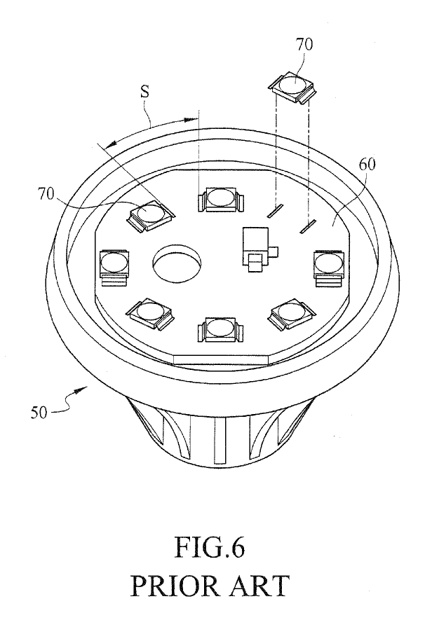

FIG. 7 is cross-sectional view illustrating angular range of illumination provided by a conventionally packaged LED that is mounted to a circuit board with surface-mounting technology (SMT).

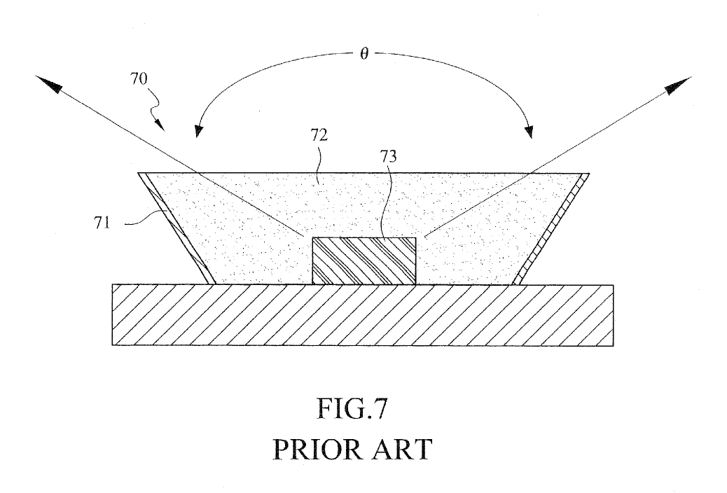

FIG. 8 is a schematic view illustrating light shape distribution contour provided by the conventional LED light bulb.

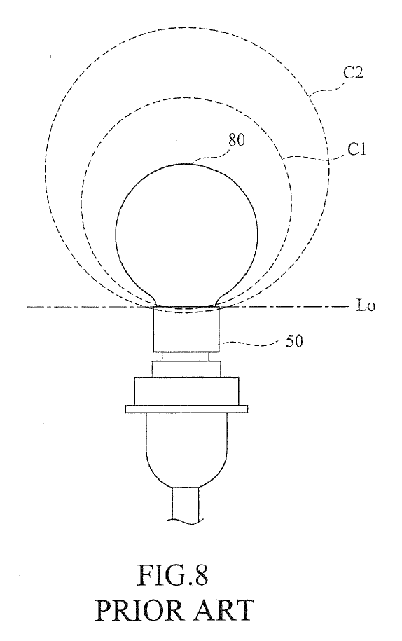

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

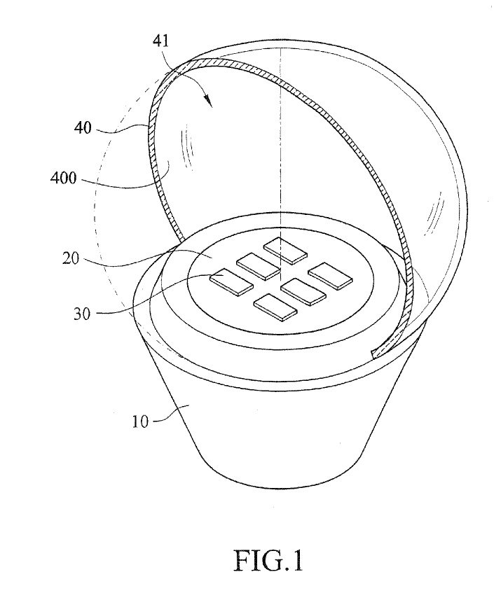

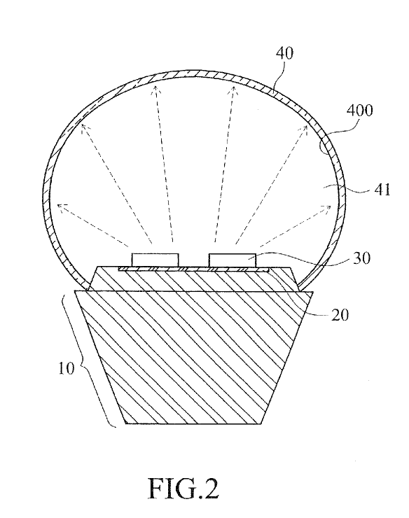

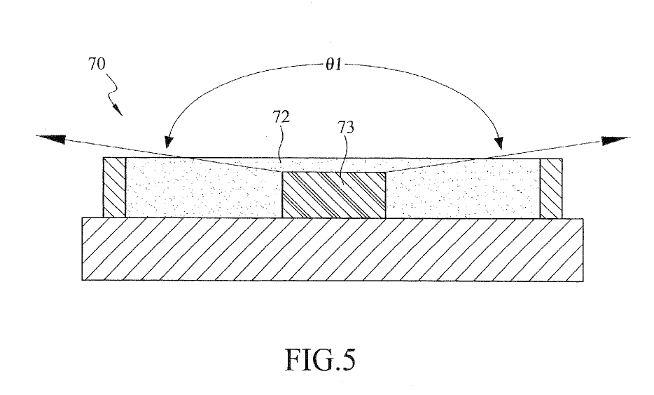

Referring to FIGS. 1 and 2, the present invention provides a light-emitting diode (LED) light bulb, which comprises a light base that is formed of a heat dissipation module 10 and has an end to which a circuit board 20 is mounted. The circuit board 20 carries thereon at least one LED 30 (of which the number is six in the embodiment illustrated). The LED 30 is mounted to the circuit board 20 in a chip-on-board (COB) fashion. Referring to FIG. 5, since the LED 30 is arranged in a COB fashion on the circuit board 20, the illumination angle of light emitting from the LED 30 is allowed to directly propagate outward from the circuit board 20 and can reach an angle range (θ1) of illumination of almost 180 degrees.

The light base heat dissipation module 10 is provided for absorb and transmit heat generated by the LED 30 and to further dissipate the heat.

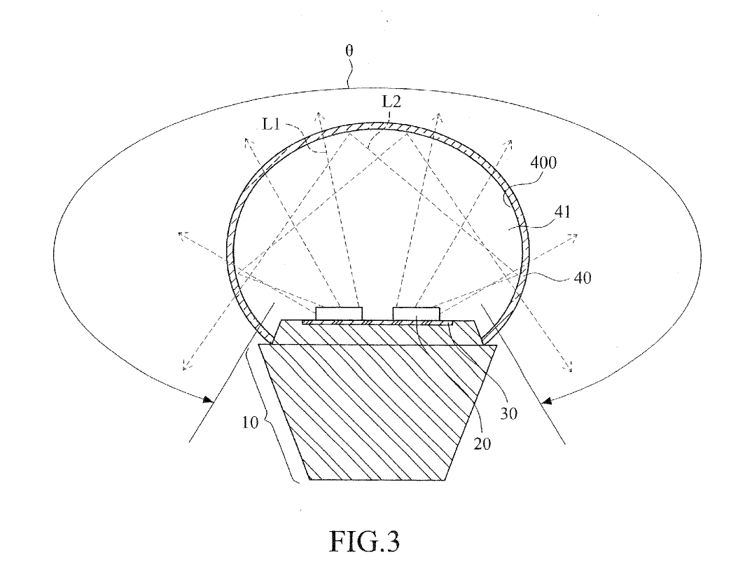

A global cover 40 is mounted to and covers above the LED 30 of the light base heat dissipation module 10. The global cover 40 has an inside surface 400 that has a spherical curvature, as shown in FIGS. 2 and 3. When the LED 30 generates intense white light, the light travels toward and uniformly irradiates the inside surface 400 of the cover 40. For a beam L1 of the light that reaches the inside surface 400 of the cover 40 with a vertical angle or a substantially vertical angle, the light beam transmits through the cover 40. For a beam L2 of the light that is projected to the inside surface 400 of the cover 40 at an excessively inclined angle, the light beam L2 will be reflected by the cover 40 repeatedly until it transmits through the cover 40. Consequently, the light bulb of the present invention provides all-direction light emission similar to the conventional light bulb.

Further, to realize uniform reflection of light inside the bulb, the inside surface 400 of the cover 40 may be coated with a reflective material that helps uniformization of light, such as a light guide film, whereby even more uniform brightness can be realized.

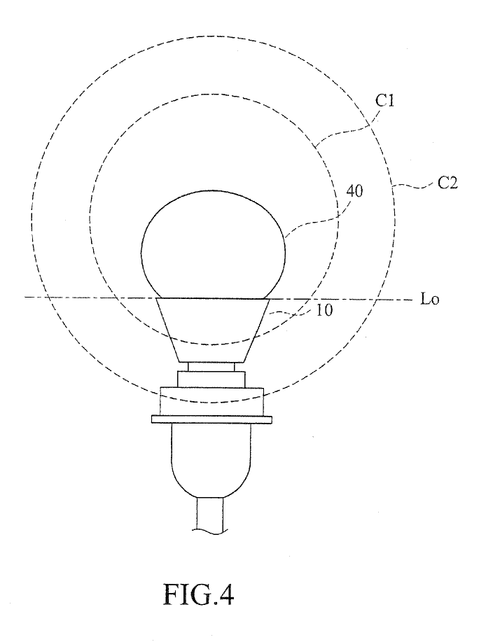

In summary, in the operation of the present invention, as shown in FIGS. 3 and 4, since in the present invention, the LED 30 is mounted to the circuit board 20 in a COB fashion, the light illumination angle of the LED 30 can get close to 180 degrees. When aided with light reflection realized by the inside surface 400 of the global cover 40, the angular range (θ) of illumination of the light bulb according to the present invention can reach at least 270 degrees. The first light shape distribution contour (C1) of primary brightness and the second light shape distribution contour (C2) of secondary brightness both cover locations below a horizontal line L0 of the end of the light base 50, making the lower portion of the light bulb sufficiently illuminated. Experiment results show that brightness of illumination of the light bulb according to the present invention can be extended to the surrounding space of the lower portion of the light bulb. Such a lighting performance is close to the radiating lighting of the conventional light bulbs. Since the light bulb of the present invention adopts LEDs as light source, the cost is high but the lifespan extends, and further, the light bulb of the present invention is better in terms of environmental conservation and emission of brightness. This is one of the major advantages of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wide-angle illumination light-emitting diode (LED) light bulb, comprising:
a light base heat dissipation module having an end to which a circuit board is mounted, the circuit board carrying at least one LED that is mounted to the circuit board in a chip-on-board fashion; and
a global cover arranged above and covering the LED of the light base heat dissipation module, whereby intense white light generated by a high-power LED is allowed to emit from the global cover with a wide angle of illumination.

2. The wide-angle illumination LED light bulb according to claim 1, wherein the cover has an inside surface coated with a light guide film for uniformizing light.
